(19) United States
(12) Patent Application Publication
(10) Pub. No.: US 2025/0359654 A1
(43) Pub. Date: Nov. 27, 2025

(54) DRIVE COUPLER FOR POWER SCRUBBER

(71) Applicant: Techtronic Cordless GP, Anderson, SC (US)

(72) Inventor: Tyler H. Knight, Mauldin, SC (US)

(21) Appl. No.: 19/296,387

(22) Filed: Aug. 11, 2025

Related U.S. Application Data
(63) Continuation of application No. 18/330,658, filed on Jun. 7, 2023, now Pat. No. 12,383,052.
Application No. 18/330,658 is a continuation of application No. 17/516,311, filed on Nov. 1, 2021, now Pat. No. 12,178,311.
(60) Provisional application No. 63/109,235, filed on Nov. 3, 2020.

(51) Int. Cl. A46B 13/02; A46B 5/00; A46B 13/00

(52) U.S. Cl. CPC A46B 13/02; A46B 5/005; A46B 5/0083; A46B 5/0095; A46B 13/008; A46B 2200/30

(57) ABSTRACT

A power scrubber including a telescopic shaft, a power receptacle, a handle, a power head, a pivot coupling, a first scrubber head, a second scrubber head, and a drive. The power receptacle and the handle are each positioned adjacent the first end. The pivot coupling couples the power head to the second end and is operable to adjust an angle of the power head relative to the shaft axis. The drive is coupled to and driven by the power head and extends along a longitudinal axis. The drive includes a first connector selectively engaging the first scrubber head with a center of the first scrubber head aligned with the longitudinal axis and a second connector selectively engaging the second scrubber head with a center of the second scrubber head aligned with the longitudinal axis. The first connector is connected to the first scrubber by a bayonet coupling.

### CROSS-REFERENCE TO RELATED APPLICATION

This application is a continuation of U.S. Non-Provisional patent application Ser. No. 18/330,658, filed Jun. 7, 2023, which is a continuation of U.S. Non-Provisional Pat. No. 17,516,311, filed Nov. 1, 2021, which claims the benefit of U.S. Provisional Patent Application No. 63/109,235, filed Nov. 3, 2020, the entire contents of which are incorporated herein by reference.

### TECHNICAL FIELD

The present disclosure relates to drive adapters, and more particularly to drive adapters for scrubbers and the like.

### BACKGROUND

Hand tools and power tools are frequently connected to different sizes and/or types of tool heads. Tool heads may include bits, fasteners, and the like. In the context of powered scrubbers, tool heads may include brushes having various sizes, shapes, and stiffnesses. Connection mechanisms that are attachable to or integral with the tool permit connection between the head and the tool. The connection mechanism permits usage of the head upon actuation of the tool. Various tool heads may require different connections to the tool.

### SUMMARY

In one independent aspect, a power tool includes a power head receiving power from a power source and a drive coupled to and driven by the power head. The drive extends along a longitudinal axis, and the drive includes a connector for selectively engaging one of a first working tool and a second working tool. The connector includes an internal bore configured to selectively engage a shank of the first working tool, and a lobe protruding radially outward from the longitudinal axis. The lobe has a locking mechanism configured to secure the second working tool in response to relative movement between the lobe and the second working tool in both an axial direction and a rotational direction.

In another independent aspect, a power scrubber includes a power head receiving power from a power source, and a drive coupled to and driven by the power head. The drive extends along a longitudinal axis, and the drive includes a connector for selectively engaging a working tool. The connector includes an external lobe protruding radially outwardly from the longitudinal axis, and a bayonet coupling angled in a rotational direction about the longitudinal axis and extending at least partially along the longitudinal axis. The bayonet coupling is configured to couple the drive with a brush having a corresponding bayonet coupling.

In yet another independent aspect, a power scrubber includes a shaft, a power source, a power head, and a drive. The shaft extends along a shaft axis between a first end and an second end, and the shaft includes a first portion adjacent the first end, and a second portion adjacent the second end. The second portion is movable relative to the first portion in a telescoping manner to adjust a length of the shaft along the shaft axis. The power source is coupled to the first end of the shaft. The power head includes a motor receiving power from the power source, and the power head is positioned adjacent the second end of the shaft. The drive is coupled to and driven by the power head, and the drive extends along a longitudinal axis. The drive includes a connector for selectively engaging one of a first working tool and a second working tool. The connector includes an internal bore configured to selectively engage a shank of the first working tool, and a lobe protruding radially outward from the longitudinal axis, the lobe having a bayonet coupling configured to engage the second working tool.

Other aspects of the disclosure will become apparent by consideration of the detailed description and accompanying drawings.

### BRIEF DESCRIPTION OF THE DRAWINGS

FIG. 1 is a perspective view of a power scrubber including a power head.

FIG. 2 is a perspective view of the power head of FIG. 1.

FIG. 3 is a top view of the power head of FIG. 1.

FIG. 4 is a cross-sectional view of the power head of FIG. 1 viewed along section 4-4 in FIG. 3.

FIG. 5 is another perspective view of the power head of FIG. 1.

FIG. 6 is another perspective view of the power head of FIG. 1.

FIG. 7 is a section view of the power head of FIG. 1 viewed along section 7-7 in FIG. 3.

FIG. 8 is a perspective view of the power head with a scrubber head attached to the power head.

FIG. 9 is a perspective view of the power head with the scrubber head removed from the power head.

FIG. 10 is an end view of the power head and scrubber head of FIG. 8.

FIG. 11 is a cross-sectional view taken along section line 11-11 in FIG. 10.

### DETAILED DESCRIPTION

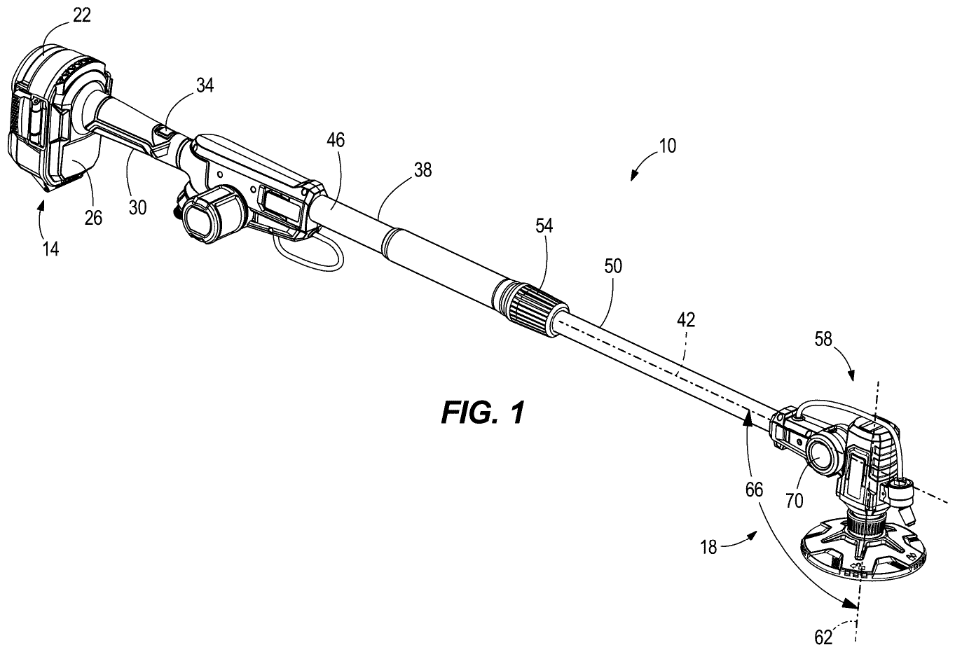

FIG. 1 illustrates a power scrubber 10. The illustrated power scrubber 10 may be a telescopic power scrubber extending between a first end 14 and an opposite a second end 18. The illustrated power scrubber 10 includes a removable power source 22 (e.g., a battery). The power source 22 is operable to engage a power receptacle 26 adjacent the first end 14. In other embodiments, the power source 22 may be integral with the power receptacle 26, and/or may receive power from a source other than a battery. A handle 30 and a trigger 34 are positioned adjacent the first end 14 of the power scrubber 10 to facilitate a user holding the handle 30 and operating the trigger 34 to actuate a power head 58 positioned adjacent the second end 18.

The power scrubber 10 includes a shaft 38 extending along a shaft axis 42 between the first end 14 and the second end 18. In the illustrated embodiment, the shaft 38 includes a first portion 46 and a second portion 50 coupled to the first portion 46 by a connector 54. The connector 54 facilitates telescoping movement of the second portion 50 relative to the first portion 46 to adjust a length of the shaft 38. In other embodiments, the shaft 38 may include more than two portions and more than one connector. In other embodiments, the power scrubber may include a fixed (i.e., non-telescoping) shaft 38. In such embodiments, the handle 30 is connected (e.g., directly connected) to a power head 58 to form a fixed, compact scrubber.

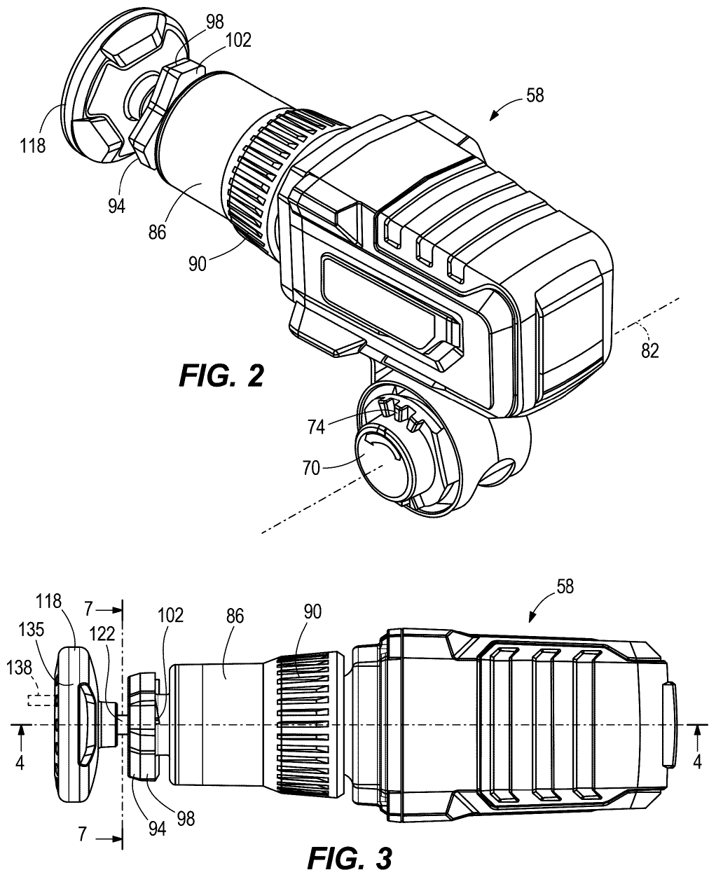

The power head 58 may be positioned adjacent the second end 18 and include a chuck or drive 86 (FIG. 2) extending along a longitudinal axis 62 (FIG. 1). The longitudinal axis 62 of the drive 86 may be oriented at an angle 66 (e.g., an acute angle, an obtuse angle, angle, etc.) relative to the shaft axis 42. A pivot coupling 70 couples the power head 58 to the shaft 38 and is operable to adjust the angle 66. As shown in FIG. 2, in the illustrated embodiment, the pivot coupling 70 may include pawls 74 that are configured to engage corresponding detents to fix the angle 66 in a desired position. In the exemplary embodiment, the pawls 74 are positioned on the portion attached to the power head 58, and the detents are positioned on the portion attached to the shaft 38. In adjusting the angle 66, the power head 58 rotates about a pivot axis 82 (FIG. 2). The angle 66 may be fixed by the pawls 74 in discrete positions corresponding to common angles. Such common angles may be, for example and without limitation, 0 degrees, 15 degrees, 30 degrees, 45 degrees, 60 degrees, 90 degrees, 105 degrees, etc. Although a pawl-and-detent design is illustrated in FIG. 2, it will be understood by persons having skill in the art that other types of couplings are contemplated, including a coupling that do not utilize discrete positions. That is, the power head 58 and longitudinal axis 62 of the drive 86 may be pivoted to any desired angle or location respective to the shaft axis 42.

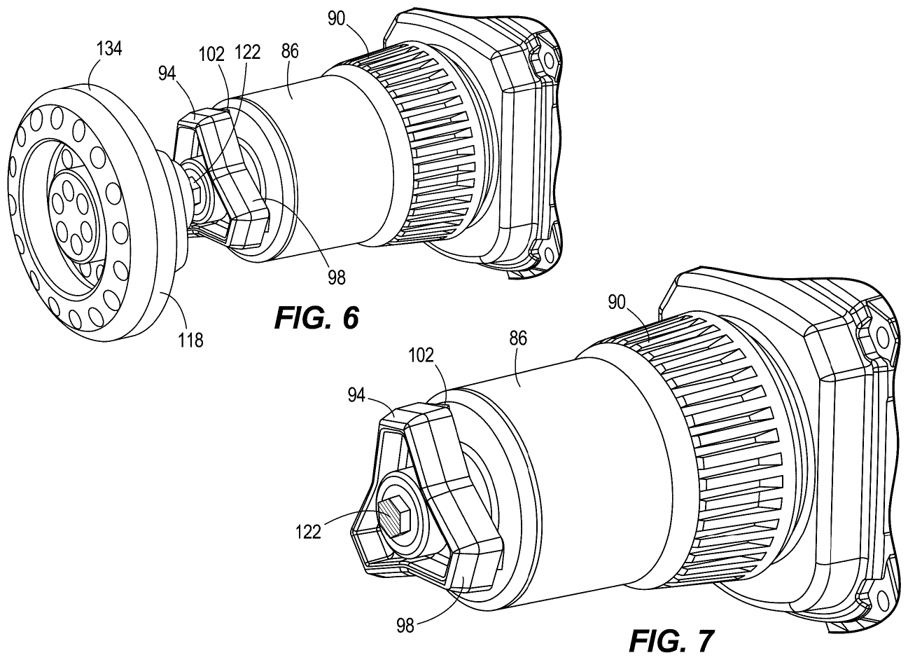

As shown in FIGS. 2-7, the drive 86 of the power head 58 is operable to rotate in response to actuation of the trigger 34. The drive 86 includes a grip 90 which can be actuated (e.g., manually rotated) about the longitudinal axis 62 of the drive 86. The drive 86 engages a connector 94 extending along the longitudinal axis 62. In the illustrated embodiment, an inner portion of the drive 86 engages an outer surface of the connector 94. The connector 94 includes lobes 98 protruding radially outwardly from the longitudinal axis 62. In the illustrated embodiment, the connector 94 includes three lobes 98 in a generally triangular pattern (see FIG. 7) with each lobe 98 equidistant from the other lobes 98. In other embodiments, the connector may include fewer or more lobes, and/or the lobes may be positioned in a different configuration, such as, without limitation, a connector 94 having four lobes 98 in a cross or X-shaped pattern, or configurations in which the lobes 98 are not equidistant from the other lobes 98.

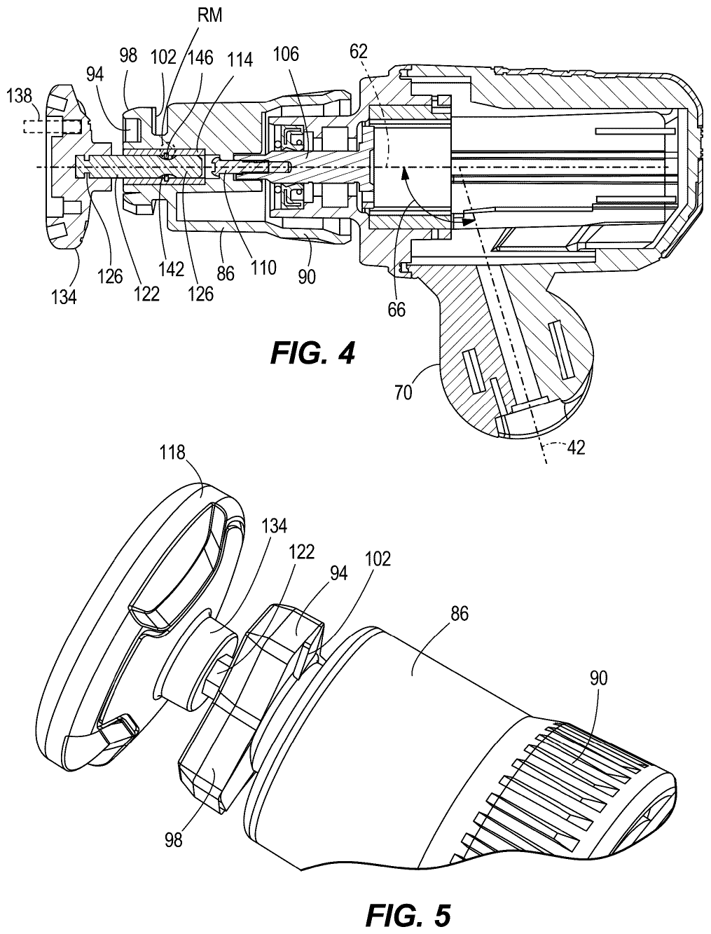

With reference to FIG. 4, each lobe 98 may include a sloping surface or ramp 102 located on an external face of the lobe 98 and extending at least partially along the longitudinal axis 62. In the illustrated embodiment, the ramp 102 extends along the longitudinal axis 62 in a rearward direction towards the drive 86. As best shown in FIG. 5, the ramp 102 may be angled in the rotational direction of the drive 86, and coupling the connector 94 to the drive 86 may require movement of at least one of the components in an axial direction and a rotational direction about the axis. For example, the connector 94 may include a bayonet coupling in which one component includes one or more pins that protrude radially and that engage and move along the ramp 102 to secure the connector. The ramp 102 may be angled relative to the longitudinal axis 62. In the illustrated embodiment, the angle of the ramp 102 extends rearwardly away from the lobe 98 and towards the drive 86. The ramp 102 is configured to couple the connector 94 with a working tool (not shown) having a corresponding bayonet coupling for engaging the ramp 102. The ramp 102 may releasably lock the position of the working tool relative to the connector 94. As such, power is at least partially transmitted from the drive 86 through the ramp 102 of the connector 94 to power the working tool. In the illustrated embodiment, the working tool may be, without limitation, a brush, pad, a scrubber, a polisher, and/or the like (not shown).

In the illustrated embodiment, the ramp 102 is a projection provided on the lobe 98 operable to engage a corresponding notch of the brush. In other embodiments, this configuration may be reversed, with the ramp 102 provided on the brush, and the corresponding notch being provided on the lobe 98. Accordingly, both the projection and the notch function as corresponding bayonet couplings.

With reference to FIG. 4, a drive mount 106 of the power head 58 is rotatably connected to the drive 86 by a drive fastener 110. As such, the drive fastener 110 can couple the drive 86 to the power head 58. In some embodiments, the drive fastener 110 may be a reverse threaded fastener.

With continued reference to FIG. 4, the connector 94 may include a drive bore 114 positioned within the connector 94 and receiving a shank 122 of a working tool to couple the working tool to the drive 86. In the illustrated embodiment, the drive bore 114 is hexagonal for engaging a hexagonal shank 122. In other embodiments, the drive bore 114 may have a different cross-sectional shape.

In the illustrated embodiment, the working tool is a scrubber head 118 having a shank 122. The shank 122 has a first end 126 and a second end 130. As shown in FIG. 4, a body 134 of the scrubber head 118 is attached at the first end 126 of the shank 122. The body 134 further includes bristles 138 for scrubbing a surface. The shank 122 includes a recess 142 for facilitating engagement with the drive 86. The drive 86 further includes a retaining ring 146 within the drive bore 114. The retaining ring 146 is configured to circumscribe the shank 122 at the recess 142 to retain the axial position of the shank 122 along the longitudinal axis 62. The recess 142 and retaining ring 146 can releasably lock the axial position of the shank 122 along the longitudinal axis 62. In other embodiments, the shank 122 may be retained in another manner.

Other embodiments may include, without limitation, an additional retention mechanism RM (FIG. 4). The retention mechanism RM may include a ball detent mechanism or a magnet. The ball detent mechanism may include a biased ball retainer configured to engage the recess 142. The magnet may be otherwise positioned on or within the shank 122 to provide magnetic force with a corresponding magnet of the connector 94 to retain the axial position of the shank 122. The corresponding magnet of the connector 94 may be positioned radially adjacent the first end 126 of the shank 122.

The cross-sectional shapes of the shank 122 and the drive bore 114 can releasably inhibit the rotation of the shank 122 about the longitudinal axis 62. The drive bore 114 is configured to couple the connector 94, and thus the drive 86, with a working tool (e.g., the scrubber head 118) having a shank (e.g., the shank 122). As such, power is transmitted from the drive 86 through the drive bore 114 of the connector 94 and the shank 122 to power the scrubber head 118.

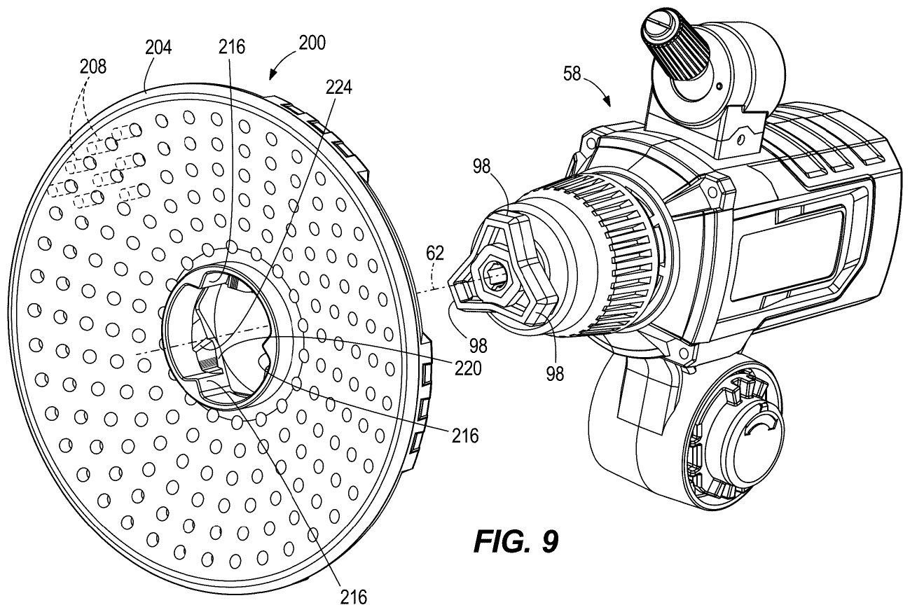

Notably, the internal drive bore 114 and/or the external lobe 98 may both be used to transmit power from the drive 86 through the connector 94 to different types of scrubber heads (e.g., 118, 200 (FIG. 9), and/or the like). In the illustrated embodiment, the scrubber head 118 includes a shank 122 configured to receive power from the internal drive bore 114. In other embodiments (see e.g., FIG. 9), the scrubber head 118 may have bayonet couplings configured to engage the lobes 98. In this way, scrubber heads having either shanks 122 or bayonet couplings may be removably coupled with the same connector 94. In this way, the power head 58 may be coupled to and employ different types of scrubber heads, thus, improving the usability and adaptability of the powered scrubber 10. In other embodiments, scrubber heads 118 may be configured to receive power from both the internal drive bore 114 and the external lobe 98 simultaneously. Such scrubber heads 118 may include both a shank 122 configured to receive power from the internal drive bore 114 and a connector as discussed above (e.g., a bayonet coupling configured to engage the ramp 102 of the lobe 98). As previously noted, other types of locking mechanisms may be used, and the other types of locking mechanisms may include relative movement both axially and radially to secure the scrubber head 118 to the drive 86.

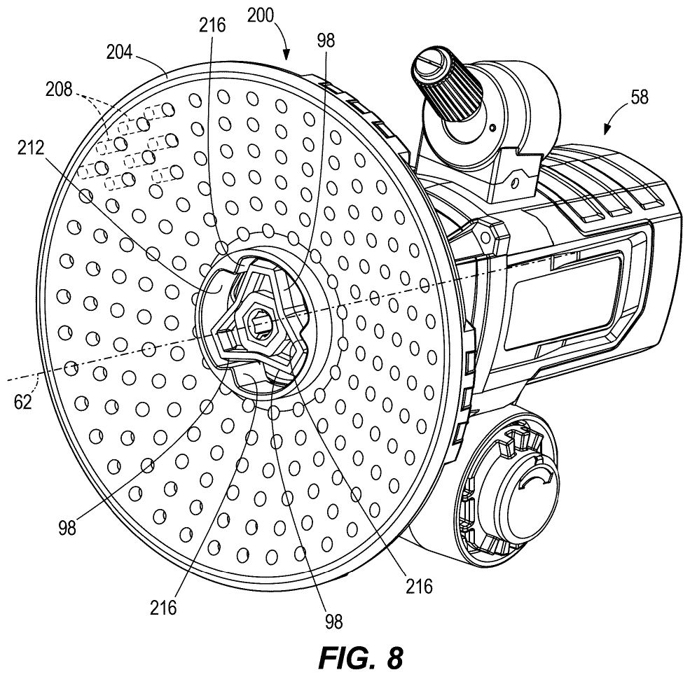

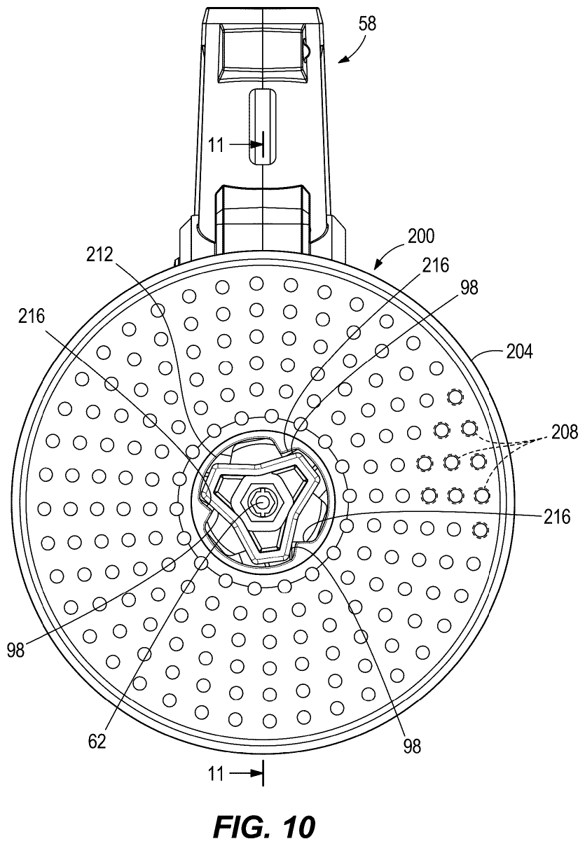

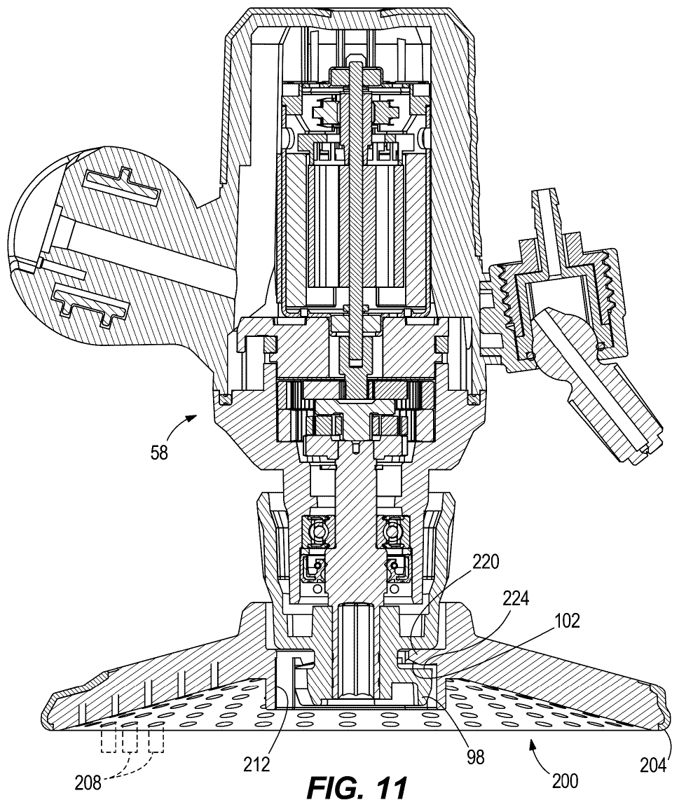

FIGS. 8-11 illustrate the power head 58 attached to a scrubber head 200. With reference to FIG. 8, the scrubber head 200 is generally dimensioned to engage the external lobes 98 and the ramps 102 of the power head 58. The scrubber head 200 includes a body 204 including bristles 208 for scrubbing a surface. The scrubber head 200 further includes an annular ring 212 at the center of the body 204 and aligned with the longitudinal axis 62. Triangular shoulders 216 extend radially inwardly from the annular ring 212 towards the longitudinal axis 62. The shoulders 216 are dimensioned to correspond with the lobes 98. Accordingly, as the drive 86 is rotated, the lobes 98 press upon the shoulder 216 to transmit torque from the drive 86 to the scrubber head 200, the bristles 208, and ultimately a work surface.

FIG. 9 illustrates the scrubber head 200 removed from the power head 58. The scrubber head 200 includes a plate 220 which extends radially inwardly from the annular ring 212 and generally perpendicular from the longitudinal axis 62. The plate 220 is located circumferentially between the shoulders 216. There is a radial gap between the plates 220 and the shoulders 216. Accordingly, the plate 220 is dimensioned to receive the lobes 98 such that the scrubber head 200 can be translated (e.g., pushed, pulled, slid, etc.) along the longitudinal axis 62 to an axial position where the scrubber head 200 is axially aligned with the lobes 98.

The plate 220 may include one or more detents 224 which correspond to the dimensions of the ramps 102. The detents 224 function as bayonet couplings, and engage the ramps 102. Each detent 224 may be configured to receive one ramp 102 of one lobe 98. Each detent 224 may include a plurality of surfaces which are angled relative to a plane perpendicular to the longitudinal axis 62. Accordingly, the angled ramps 102 may be wedged in the detents 224 to secure the lobes 98 to the scrubber head 200. While in the above-described axial position, the scrubber head 200 can be rotated to a radial position in which at least one of the plurality of surfaces of the detents 224 receive the ramps 102. Accordingly, the detents 224 can lock the scrubber head 200 to the drive 86 for co-rotation therewith.

Although aspects of the disclosure have been described in detail with reference to certain embodiments, variations and modifications exist within the scope and spirit of one or more independent aspects as described. Various features and advantages are set forth in the following claims.

What is claimed is:

1. A power scrubber system comprising:
a first scrubber head of a first type, the first scrubber head including a first scrubber head connector;
a second scrubber head of a second type different than the first type, the second scrubber head including a second scrubber head connector; and
a power scrubber including a power head configured to receive power from a power source and a drive coupled to and driven by the power head, the drive extending along a longitudinal axis;
wherein the drive is selectively couplable with the first scrubber head connector and the second scrubber head connector to transmit force from the power head to the connected scrubber head.

2. The power scrubber system of claim 1, wherein the first scrubber head and the second scrubber head are each selectively engageable with the power scrubber simultaneously such that the first scrubber head and the second scrubber head and the second scrubber head can be configured to receive power from the drive simultaneously.

3. The power scrubber system of claim 1, wherein the first scrubber head and the second scrubber head are each rotatable about the longitudinal axis upon coupling of the corresponding scrubber head to the power scrubber and actuation of the drive.

4. The power scrubber system of claim 1, wherein the first scrubber head and the second scrubber head are each rotatable in a direction parallel to the longitudinal axis upon coupling of the corresponding scrubber head to the power scrubber and actuation of the drive.

5. The power scrubber system of claim 1, wherein the drive defines a lobe engageable with the first scrubber head.

6. The power scrubber system of claim 5, wherein the lobe is an external lobe protruding radially outwardly from the longitudinal axis, and wherein the first scrubber head includes an inwardly extending shoulder engageable with the lobe.

7. The power scrubber system of claim 5, wherein the first scrubber head is engageable with the lobe by movement in an axial direction along the longitudinal axis and a rotational direction about the longitudinal axis.

8. The power scrubber system of claim 1, wherein the drive defines a drive bore engageable with a shank of the first scrubber head.

9. A power scrubber system comprising:
a first scrubber head of a first type including a first scrubber head connector;
a second scrubber head of a second type including a second scrubber head connector; and
a power scrubber including
a shaft extending along a shaft axis between a first end and a second end, the shaft including a first portion and a second portion, the second portion movable relative to the first portion in a telescoping manner to adjust a length of the shaft along the shaft axis,
a power receptacle configured to receive power from a power source, the power receptacle being positioned adjacent the first end of the shaft,
a handle positioned adjacent the first and of the shaft,
a power head including a motor configured to receive power from the power source, the power head positioned adjacent the second end of the shaft,
a pivot coupling that couples the power head to the second end of the shaft, the pivot coupling operable to adjust an angle of the power head relative to the shaft axis, and
a drive coupled to and driven by the power head, the drive extending along and rotatable about a longitudinal axis, the drive being selectively couplable with the first scrubber head via the first scrubber head connector and the second scrubber head via the second scrubber head connector.

10. The power scrubber system of claim 9, wherein the pivot coupling is rotatable about a pivot axis transverse to the shaft axis.

11. The power scrubber system of claim 10, wherein the pivot coupling includes pawls configured to engage corresponding detents to fix the power head at a desired rotation angle.

12. The power scrubber system of claim 11, wherein the pawls fix the power head at one of a plurality of discrete common angles.

13. The power scrubber system of claim 10, wherein the pivot coupling may be operable to adjust the angle of the power head between an acute angle and an obtuse angle relative to the shaft axis.

14. The power scrubber system of claim 9, further comprising a connector for facilitating telescoping movement of the second portion relative to the first portion to adjust the length of the shaft.

15. The power scrubber system of claim 9, wherein the power source is a battery.

16. The power scrubber system of claim 9, further comprising a trigger positioned adjacent the handle, wherein the trigger is operable to actuate the power head.

17. A power scrubber system comprising:
a first scrubber head of a first type including a first scrubber head connector;
a second scrubber head of a second type including a second scrubber head connector; and
a power scrubber including
a power receptacle configured to receive power from a power source;
a power head including a motor configured to receive power from the power source, the power head positioned remote to the power receptacle, and
a drive coupled to and driven by the power head, the drive extending along and rotatable about a longitudinal axis, the drive being selectively couplable with the first scrubber head via the first scrubber head connector and the second scrubber head via the second scrubber head connector.

18. The power scrubber system of claim 17, wherein the first scrubber head connector includes a first shoulder and the second scrubber head connector includes a second shoulder, and wherein the drive defines a lobe selectively couplable with the first shoulder and the second shoulder.

19. The power scrubber system of claim 17, wherein the first scrubber head connector includes a first shank and the second scrubber head connector includes a second shank, and wherein the drive defines a drive bore selectively couplable with the first shank and the second shank.

20. The power scrubber system of claim 17, wherein the power head and the power receptacle are positioned at opposite ends of the power scrubber.
